(19) United States
(12) Patent Application Publication
(10) Pub. No.: US 2020/0257166 A1
(43) Pub. Date: Aug. 13, 2020

(54) METHOD AND SYSTEM FOR TRANSFLECTIVE DISPLAY

(71) Applicant: Sharp Kabushiki Kaisha, Osaka (JP)

(72) Inventors: Nathan James Smith, Oxford (GB); Andrew Acreman, Oxford (GB)

(21) Appl. No.: 16/274,524

(22) Filed: Feb. 13, 2019

(51) Int. Cl. G02F 1/1335; G02F 1/13363; G02F 1/1368; G09G 3/36; G02F 1/1337

(52) U.S. Cl. CPC G02F 1/133555; G02F 1/133536; G02F 1/13363; G02F 1/1368; G09G 2300/0452; G02F 1/1337; G02F 2001/133638; G02F 2203/09; G09G 2300/0456; G09G 3/3648

(57) ABSTRACT

A transflective display has a viewing side and a non-viewing and includes a front polarizer with a transmission axis arranged in a first direction; a front substrate coupled to the non-viewing side of the front polarizer; a liquid crystal (LC) layer coupled to the non-viewing side of the front substrate; a quantum rod layer with one or more quantum rods aligned in a second direction, wherein the quantum rod layer is coupled to the non-viewing side of the LC layer; a rear substrate coupled to the non-viewing side of the quantum rod layer; and a backlight coupled to the non-viewing side of the quantum rod layer, wherein the quantum rod layer emits partially polarized light with a major axis substantially parallel (i.e. within ±15°) to the second direction. Each of the one or more quantum rods includes a long axis and a short axis, and the long axis is substantially parallel to the second direction.

### TECHNICAL FIELD

The present disclosure relates generally to display devices and, more particularly, to transflective liquid crystal display devices using quantum rods.

### BACKGROUND ART

Methods and systems using nanoparticles to improve the contrast ratio and brightness of a display have been used to enable better image quality. Conventional liquid crystal displays (LCDs), such as US 2016/0003998 (Benoit et al., published Jan. 7, 2016), may use an in-plane switching LC mode in combination with a Quantum Dot Enhancement Film (QDEF). US 2013/0335677 (You, published Dec. 19, 2013) describes the use of a blue backlight in combination with a QDEF sheet, a dichroic filter (to recycle blue light back to the QDEF sheet), and a conventional color filter. The QDEF sheet may contain a polymer host with a uniform mixture of quantum dots (Qdots) which converts a first portion of the blue light into red and green wavelengths. KR 20070094679 (Jiang et al.) describes an LCD which incorporates patterned quantum dot color filters that can be used to replace a conventional absorptive color filter for red and green sub-pixels in combination with a blue backlight and an LC layer which acts as an optical shutter. U.S. Pat. No. 9,983,439 (Mizunuma et al., issued May 29, 2018) describes a display device which uses a patterned quantum rod color filter to emit polarized light with a wavelength different from the excitation light. US 2017/0255060 (Kim et al., published Sep. 7, 2017) describes a color filter that uses quantum rods to emit polarized light.

Transflective devices attempt to improve image quality in all viewing conditions. The term “transflective” is a combination term of transmissive and reflective. Conventional transflective devices such as U.S. Pat. No. 7,965,357 (Van De Witte et al., issued Jun. 21, 2011) describe an LCD containing a reflector which is patterned to contain apertures. The device acts so that a single pixel can operate as both a reflective and transmissive display. The optics in such a system are designed such that in the dark state of the display, both light from the backlight (which passes though the aperture in the patterned reflector) and ambient light (reflected from the patterned reflector) are absorbed by a polarizer layer, while in the bright state both ambient light and light from the backlight are emitted by the device. The patterned reflector results in low efficiency because a significant amount of light emitted by the backlight is blocked.

Koma et al. (514-516 IDW 2017, and doi:10.1002/sdtp.12304) describes a single area transflective device which does not require a patterned reflector. Koma incorporates a patterned quantum dot color filter which is on the non-viewing side of the LCD. Light from the backlight stimulates the quantum dots which are then selectively transmitted by the LCD layer. In high ambient light conditions, the quantum dots absorb and re-emit the ambient light supplementing the light from the backlight. Such a device is still inefficient as it requires a high-quality internal polarizer due to the depolarization effects of the quantum dots. The interaction between the quantum dots and the internal polarizer means that approximately 50% of the light from the backlight is absorbed by the internal polarizer. The interaction between the quantum dots and the polarizers means that approximately 75% of the light from the ambient environment is absorbed by the polarizers. Accordingly, there is a need in the art for improved transflective displays under all lighting conditions.

### SUMMARY OF INVENTION

The present invention relates to a transflective liquid crystal display (LCD) that can form an image using the same area of a sub-pixel to both reflect light (e.g., ambient lighting) and transmit light (e.g., from a backlight). An advantage of a transflective device is to enable better image quality and lower power consumption than a transmissive display when the displays are viewed in an environment with high ambient lighting, such as for example direct sunlight or bright indoor lighting. An advantage of a transflective device is to enable better image quality than a reflective display when the displays are viewed in an environment with low ambient lighting, such as for example at night or under relatively dim indoor conditions. To achieve improved image quality, the present invention utilizes a single area transflective pixel in combination with quantum rods that emit polarized light to improve image brightness and contrast ratio.

An aspect of the invention, therefore, is a transflective display that can form an image by both transmitting and reflecting light from the same sub-pixel areas. In exemplary embodiments, the transflective display has a viewing side and a non-viewing side and includes a front polarizer with a transmission axis arranged in a first direction; a front substrate coupled to the non-viewing side of the front polarizer; a liquid crystal (LC) layer coupled to the non-viewing side of the front substrate; a quantum rod layer with one or more quantum rods aligned in a second direction, wherein the quantum rod layer is coupled to the non-viewing side of the LC layer; a rear substrate coupled to the non-viewing side of the quantum rod layer; and a backlight coupled to the non-viewing side of the quantum rod layer, wherein the quantum rod layer emits at least partially polarized light with a major axis substantially parallel (i.e. within ±15°) to the second direction. Preferably, the quantum rod layer emits linearly polarized light with a major axis parallel to the second direction. The rear substrate may be a non-thin film transistor (TFT) substrate and the front substrate is a TFT substrate, or the rear substrate may be a TFT substrate and the front substrate is a non-TFT substrate. Each of the one or more quantum rods includes a long axis and a short axis, and the long axis is substantially parallel to the second direction.

Another aspect of the invention is a method of operating the enhanced transflective display. In exemplary embodiments, the method includes operating in a black state by the steps of: transmitting, by a front linear polarizer with a first transmission axis, incoming light (ambient light) with a polarization in a first direction parallel to the first transmission axis; configuring a liquid crystal (LC) layer to introduce zero phase shift the polarization of the incoming light; passing, by a quantum rod layer, the incoming light, wherein the quantum rod layer has a plurality of quantum rods aligned in a second direction perpendicular to the first transmission axis; absorbing, by a rear linear polarizer with a second transmission axis in the second direction perpendicular to the first transmission axis, the incoming light; generating, by a backlight, emitted light with a random polarization; absorbing, by the rear linear polarizer, emitted light with a polarization not parallel to the second transmission axis; transmitting, by the rear linear polarizer, emitted light with a polarization parallel to the second transmission axis; exciting, by the emitted light with the polarization parallel to the second transmission axis, quantum rods aligned in the second direction; emitting, by the excited quantum rods, colored light polarized in the second direction; and absorbing, by the front linear polarizer with the first transmission axis, the colored light polarized in the second direction.

The method of operating further may include operating in a color or white state by the steps of: applying a voltage to the LC layer to configure the LC layer to introduce a non-zero phased shift (up to λ/2 phase shift) to light incident on the LC layer; rotating, by the LC layer, the polarization of the incoming light to the second direction; exciting, by the incoming light with the polarization in the second direction, quantum rods aligned in the second direction; emitting, by the excited quantum rods, colored light polarized in the second direction; rotating, by the LC layer, the polarization of the colored light to the first direction; and transmitting, by the front polarizer with the first transmission axis, the colored light polarized in the first direction.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 defines a coordinate system for illustrating pertinent terms of orientation used in this disclosure.

FIG. 2 defines a coordinate system pertaining to the in-plane angle φ identified in FIG. 1.

FIG. 3 is a plan view of a conventional transflective sub-pixel.

FIG. 4 is a plan view of a transflective sub-pixel in accordance with embodiments of the present invention.

FIG. 5 is a schematic drawing depicting an exemplary LCD optical stack arrangement of a transflective display device in accordance with embodiments of the present invention.

FIG. 6 is a schematic drawing depicting another exemplary LCD optical stack arrangement of a transflective display device in accordance with embodiments of the present invention.

FIG. 7 is a schematic drawing depicting another exemplary LCD optical stack arrangement of a transflective display device in accordance with embodiments of the present invention.

FIG. 8 is a schematic drawing depicting another exemplary LCD optical stack arrangement of a transflective display device in accordance with embodiments of the present invention.

FIG. 9 is a schematic drawing depicting another exemplary LCD optical stack arrangement of a transflective display device in accordance with embodiments of the present invention.

FIG. 10 is a schematic drawing depicting another exemplary LCD optical stack arrangement of a transflective display device in accordance with embodiments of the present invention.

FIG. 11 is a schematic drawing depicting another exemplary LCD optical stack arrangement of a transflective display device in accordance with embodiments of the present invention.

FIG. 12 is a schematic drawing depicting another exemplary LCD optical stack arrangement of a transflective display device in accordance with embodiments of the present invention.

FIG. 13 is a schematic drawing depicting an arrangement of a rear polarizer suitable for a transflective display device in accordance with embodiments of the present invention.

FIG. 14 is a schematic drawing depicting an arrangement of another rear polarizer suitable for a transflective display device in accordance with embodiments of the present invention.

FIG. 15 is a schematic drawing depicting an arrangement of another rear polarizer suitable for a transflective display device in accordance with embodiments of the present invention.

FIG. 16 is a schematic drawing depicting an arrangement of a rear polarizer and retarder suitable for a transflective display device in accordance with embodiments of the present invention.

FIG. 17 is a schematic drawing depicting an arrangement of external and internal quarter wave plates on opposite sides of the front substrate of a transflective display device in accordance with embodiments of the present invention.

FIG. 18A is a schematic drawing depicting the operation of polarization optics in a transflective display device in a black state in accordance with embodiments of the present invention.

FIG. 18B is a schematic drawing depicting the operation of polarization optics in a transflective display device in a white state in accordance with embodiments of the present invention.

FIG. 19 is a schematic drawing depicting another exemplary LCD optical stack arrangement of a transflective display device in accordance with embodiments of the present invention.

FIG. 20A is a schematic drawing of an exemplary arrangement of an aligned quantum rod layer and a selective reflection layer in accordance with embodiments of the present invention.

FIG. 20B is a further schematic drawing of an exemplary arrangement of an aligned quantum rod layer and a selective reflection layer in accordance with embodiments of the present invention.

FIG. 20C is a further schematic drawing of an exemplary arrangement of an aligned quantum rod layer and a pair of selective reflection layers in accordance with embodiments of the present invention.

FIG. 21A is a schematic drawing of an exemplary arrangement of the TFT substrate and associated layers in accordance with embodiments of the present invention.

FIG. 21B is a further schematic drawing of an exemplary arrangement of the TFT substrate and associated layers in accordance with embodiments of the present invention.

FIG. 21C is a further schematic drawing of an exemplary arrangement of the TFT substrate and associated layers in accordance with embodiments of the present invention.

FIG. 21D is a further schematic drawing of an exemplary arrangement of the TFT substrate and associated layers in accordance with embodiments of the present invention.

FIG. 21E is a further schematic drawing of an exemplary arrangement of the TFT substrate and associated layers in accordance with embodiments of the present invention.

### DESCRIPTION OF EMBODIMENTS

Embodiments of the present invention will now be described with reference to the drawings, wherein like reference numerals are used to refer to like elements throughout. It will be understood that the figures are not necessarily to scale.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

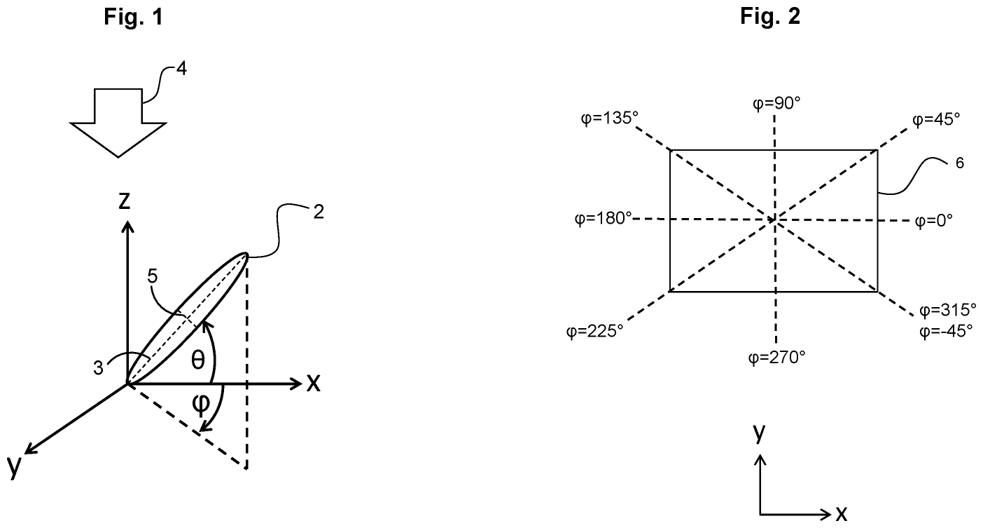

For illustrative purposes, FIG. 1 defines a coordinate system for illustrating pertinent terms of orientation used in this disclosure. The axes x, y and z are orthogonal to each other. The angle between the x-axis and the y-axis is defined as the in-plane angle φ, with the term in-plane more particularly referring to being parallel to the plane of an LCD device. The angle between the x-axis (or y-axis) and the z-axis is the out-of-plane angle θ relative to the plane of an LCD device. For reference, an illustrative molecule 2 such as a quantum rod or LC molecule is depicted as may be oriented within a layer; and a viewing direction 4 of a viewer along the z-axis is also shown. The molecule 2 may be characterized by a long axis 3 and a short axis 5. FIG. 2 defines a related coordinate system pertaining to the in-plane angle φ identified in FIG. 1. In particular, FIG. 2 shows a range of positioning of the in-plane angle φ with respect to an LCD device from the perspective of a viewing position relative to a generalized LCD device 6.

Quantum rods discussed herein may be represented by the molecule 2. Whereas quantum dots are approximately spherical in shape, quantum rods are approximately elliptical or cylindrical in shape as illustrated in FIG. 1. A quantum rod may be characterized by an aspect ratio determined by dividing the long axis 3 by the short axis 5. In some embodiments, quantum rods described herein may have an aspect ratio >1.5. In additional embodiments, quantum rods described herein may have an aspect ratio >2. Furthermore, for a given wavelength of light, the radius of a quantum dot may be less that the Bohr radius whereas the length, e.g., long axis 3, of a quantum rod may be greater than the Bohr radius (the cross-section of the quantum rod, e.g., short axis 5, is also less than the Bohr radius). Because the length of the quantum rod is greater than the Bohr radius, the quantum rod layer may emit light that is at least partially polarized if one or more quantum rods in an aligned quantum rod layer is optically stimulated. In contrast, if a quantum dot is optically stimulated, the quantum dot may emit light that is substantially unpolarized. The advantage of quantum rods over quantum dots for all embodiments described herein is that light emitted by a quantum rod is more polarized (i.e., has a greater degree of polarization) than light emitted by a quantum dot.

Consequently, the quantum rod transflective display devices described herein may be more efficient (i.e. have lower power consumption) than quantum dot transflective display devices. The degree of polarization, V, of light is defined by V=IA/(IA+IB) where IA is the intensity of polarized light and IB is the intensity of unpolarized light. The degree of polarization for perfectly polarized light is V=1 and the degree of polarization for perfectly unpolarized light is V=0. The degree of polarization for light, V, emitted at room temperature from an aligned quantum rod layer such as in the embodiments described herein may be greater than 0.3. In some embodiments, the degree of polarization for light, V, emitted at room temperature from an aligned quantum rod layer such as the embodiments described herein may be greater than 0.5.

The embodiments described herein emit light from an aligned quantum rod layer with a degree of polarization, V, closer to 1 to enable more efficient (e.g., lower power consumption) quantum rod transflective display devices with brighter images. A quantum rod transflective display may demonstrate commercial advantage with regard to lower power consumption and brighter images provided that the emission of light from an aligned quantum rod layer has a degree of polarization that is >0.3 and preferably >0.5. The phase “at least partially polarized” is understood to mean that light has a degree of polarization greater than 0.3. Additionally, a quantum rod transflective display may demonstrate commercial advantage with regard to lower power consumption and brighter images provided that the polarized component of light emitted from the aligned quantum rod layer has an ellipticity of less than 0.7, where the ellipticity is defined by a ratio b/a where “b” is the intensity of the minor elliptical axis and “a” is the intensity of the major elliptical axis. The phase “substantially linearly polarized” is understood to mean that light has an ellipticity (a/b) <0.7. The major axis may be substantially parallel (i.e. within ±15°) to the long axis 3 of the quantum rod depicted in FIG. 1. For diagrammatic and descriptive convenience, the embodiments described herein show that the emission of light from an aligned quantum rod layer has a degree of polarization of 1 (i.e., perfectly polarized) and is linearly polarized with the major polarization axis aligned parallel to the long axis of the quantum rod.

### Conventional Transflective Display

FIG. 3 is a plan view of a conventional transflective sub-pixel. A plan view (x-y plane) of a sub-pixel 8 (i.e. a pixel with a colored filter) pertaining to a conventional transflective LCD is shown in FIG. 3 and may include a transmissive area 11, a reflective area 12 and a black mask area 14. The transmissive area 11 and the reflective area 12 are spatially distinct in conventional transflective displays. The optical configuration of the transmissive area 11 and the reflective area 12 are different to correctly modulate light from a transmissive source (such as a backlight) and a reflective source (such as ambient light) respectively.

When a conventional transflective display is used in an environment with high ambient lighting, the performance of the reflective area 12 of the sub-pixel 8 dominates the image quality. For example, a transflective display using the conventional transflective sub-pixel 8 design can be realized that has superior image quality to a transmissive display when viewed in an environment with high ambient lighting. However, the transflective display will have inferior image quality to said transmissive display when viewed in an environment with low ambient lighting. Consequently, it is not possible for a conventional transflective display using sub-pixel 8 to have better image quality than a transmissive display in all ambient lighting conditions.

When a conventional transflective display is used in an environment with low ambient lighting, the performance of the transmissive area 11 of the sub-pixel 8 dominates the image quality. Using a conventional transflective sub-pixel 8 design, a transflective display can be realized that has superior image quality to a reflective display when viewed in an environment with low ambient lighting. However, the transflective display using the conventional sub-pixel 8 design will have inferior image quality to said reflective display when viewed in an environment with high ambient lighting. Consequently, it is not possible for a conventional transflective display to have better image quality than a reflective display in all ambient lighting conditions. In general, a conventional transflective display with a conventional sub-pixel 8 design has limited commercial appeal because of reduced image quality in an environment with low ambient lighting.

### Transflective Sub-Pixel

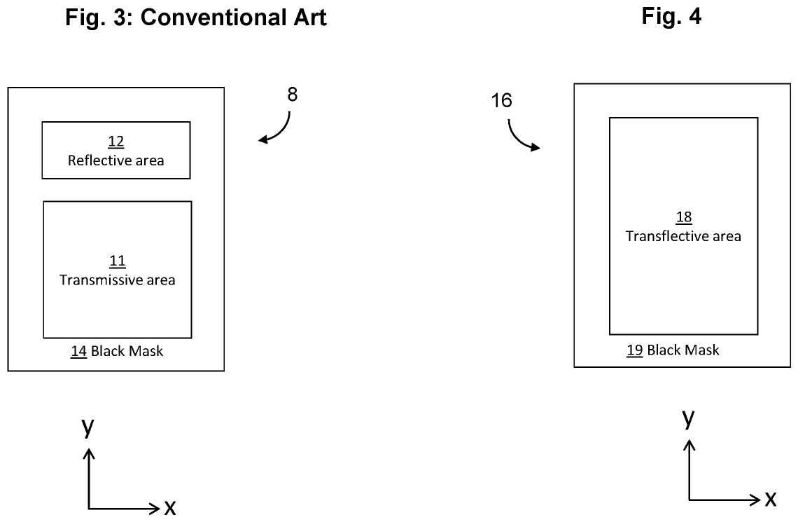

FIG. 4 is a plan view of a transflective sub-pixel in accordance with embodiments of the present invention. A plan view (x-y plane) of a sub-pixel 16 (e.g., a pixel with a colored filter) shows an enhanced transflective LCD and includes a transflective area 18 and a black mask area 19. Unlike the conventional transflective sub-pixel 8, there is no distinct reflective area 12 or transmissive area 11 in the enhanced transflective sub-pixel 16. The transflective area 18 may perform the function of both the transmissive area 11 and the reflective area 12. In particular, the transflective area 18 can simultaneously modulate light from a transmissive source (such as a backlight) and a reflective source (such as ambient light) in the same spatial area of the sub-pixel 16.

In transmission, the brightness of the transflective display using sub-pixel 16 may be higher than a conventional transflective display because the transflective area 18 of sub-pixel 16 is larger than the transmissive pixel area 11 of sub-pixel 8. In reflection, the brightness of a transflective display using sub-pixel 16 may be higher than a conventional transflective display using sub-pixel 8 because the transflective area 18 is larger than the reflective area 12. Consequently, a transflective display using sub-pixel 16 has better image quality than a conventional transflective display using sub-pixel 8 in all ambient lighting conditions.

An aspect of the invention is a transflective display that can form an image by both transmitting and reflecting light from the same sub-pixels. In exemplary embodiments, the transflective display has a viewing side and a non-viewing and includes a front polarizer with a transmission axis arranged in a first direction; a front substrate coupled to the non-viewing side of the front polarizer; a liquid crystal (LC) layer coupled to the non-viewing side of the front substrate; a quantum rod layer with one or more quantum rods aligned in a second direction, wherein the quantum rod layer is coupled to the non-viewing side of the LC layer; a rear substrate coupled to the non-viewing side of the quantum rod layer; and a backlight coupled to the non-viewing side of the quantum rod layer, wherein the quantum rod layer emits partially polarized light with a major axis substantially parallel (i.e. within ±15°) to the second direction. Each of the one or more quantum rods includes a long axis and a short axis, and the long axis is substantially parallel to the second direction.

Optical Stack with TFT Substrate on Viewing Side

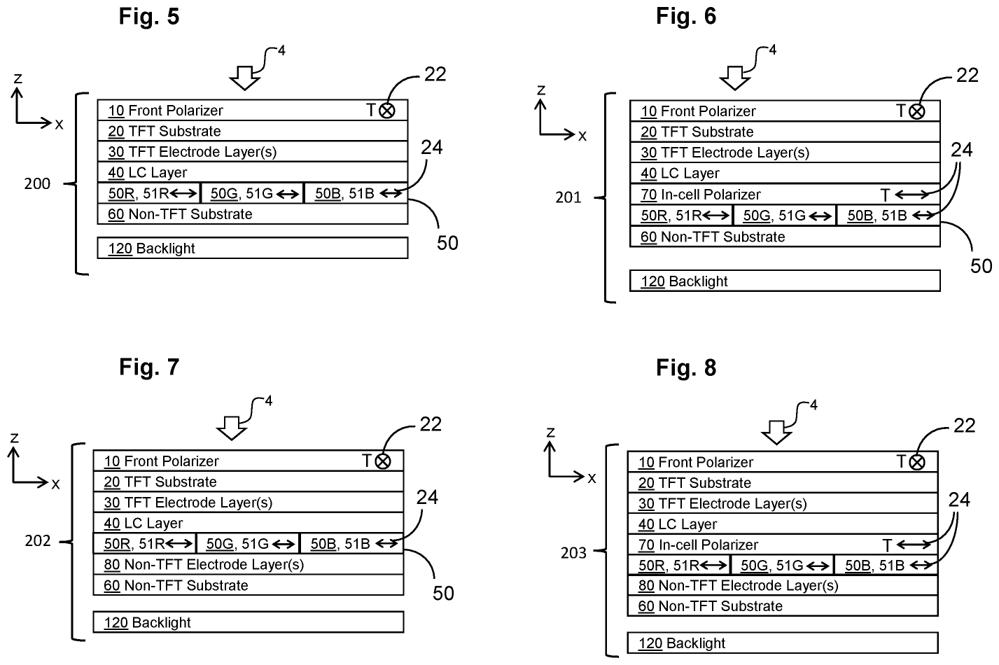

FIG. 5 is a schematic drawing depicting an exemplary LCD optical stack arrangement of a transflective display device in accordance with embodiments of the present invention, with a transflective pixel 200 being shown. It will be appreciated that any suitable number of pixels may be combined into a broader overall display device. A transflective pixel 200 of a quantum rod transflective display device includes, from the viewing direction 4 along the z-axis, a front linear polarizer 10 with a transmission axis arranged to transmit light with a first polarization in a first direction 22 (parallel to the y-axis), a thin-film transistor (TFT) substrate 20, one or more TFT electrode layers 30, a liquid crystal (LC) layer 40, a patterned color quantum rod layer 50, a non-TFT substrate 60, and a backlight 120. In FIG. 5, the TFT substrate 20 may be known as the “front substrate” or “viewing side substrate” while the non-TFT substrate 60 may be known as the “rear substrate” or “non-viewing side” substrate”.

The patterned color quantum rod layer 50 may include one or more aligned quantum rod layers such as 50R, 50G, and 50B, which may correspond to different color wavelengths of light emission such as for example red, green, and blue. One or more quantum rods in each layer may be characterized by a long axis such as long axis 3 shown on illustrative molecule 2 in FIG. 1. An alignment direction of the one or more aligned quantum rod layers is parallel to the long axis of the quantum rods. In some embodiments an aligned quantum rod layer can be configured to be optically stimulated by either polarized light of a first wavelength range or unpolarized of the first wavelength range.

For example, the first wavelength range may have wavelengths in the near ultra-violet (UV), and/or the blue part of the optical spectrum, and/or the green part of the optical spectrum. A properly configured patterned color quantum rod layer 50 can be optically stimulated by the first wavelength range and may emit light of a second wavelength range that may be at least partially polarized (i.e., light emitted by the color quantum rod layer 50 has a degree of polarization, V, greater than 0.3) with a major polarization axis aligned substantially parallel (i.e. within ±15°) to the long axis of the quantum rods in the patterned color quantum rod layer 50. Hereafter, the description of light emitted from a quantum rod includes linearly polarized light with the major polarization axis aligned substantially parallel (i.e. within ±15°) to the long axis of the quantum rods in the patterned color quantum rod layer 50. In some embodiments, the second wavelength range may have a shorter wavelength than the first wavelength range.

The second wavelength range may be different for each different aligned quantum rod layer of the patterned color quantum rod layer 50. In some embodiments, the aligned quantum rod layer 50R is configured for emission of red light 51R, the aligned quantum rod layer 50G is configured for emission of green light 51G, and the aligned quantum rod layer 50B is configured for emission of blue light 51B. The second wavelength range may be a function of the materials that comprise the quantum rod and/or the aspect ratio of the quantum rod. Referring to FIG. 1 and the elliptical molecule 2, the aspect ratio can be determined using the long axis 3 and the short axis 5 of the quantum rod. For example, in exemplary embodiments the aspect ratio may be between 1.25:1 and 20:1, although the aspect ratio may be selected as suitable for any particular application. The patterned color quantum rod layer 50 may be formed using quantum rods and at least one or more of a host matrix, anisotropic dye(s), isotropic dye(s), anisotropic scattering particles, isotropic scattering particles, and the like.

Embodiments of the patterned color quantum rod layer 50 may, after optical stimulation, emit red light 51R that is substantially linearly polarized, green light 51G that is substantially linearly polarized, and blue light 51B that is substantially linearly polarized. In this context, the phrase “substantially linearly polarized” means the degree of polarization, V, is greater than 0.3 and/or the ellipticity (a/b) of the polarized light is less than 0.7. Note: emission of red light 51R, green light 51G and blue light 51B is shown to be perfectly linearly polarized (i.e. the degree of polarization, V=1 and the ellipticity (a/b)=0) in FIG. 5 and other similar figures for diagrammatic convenience. In some embodiments, the aligned quantum rod layers 50R, 50G and 50B are patterned to form red, green and blue sub-pixels. The LC layer 40 within the quantum rod transflective display device 200 may be controlled via an array of TFTs and electrodes to simultaneously modulate the amount of light transmitted through, and reflected from, each red, green and blue sub-pixel.

Each of the aligned quantum rod layers 50R, 50G and 50B may be aligned in a second direction 24 that may be parallel to the x-direction. When the aligned quantum rod layers 50R, 50G, 50B are optically stimulated by light from either the backlight 120 and/or ambient lighting from the viewing direction 4, a red sub-pixel corresponding to layer 50R, a green sub-pixel corresponding to layer 50G, and a blue sub-pixel corresponding to layer 50B may emit light linearly polarized in the second direction 24 (parallel to the x-direction) of the respective color. The first direction 22 parallel to the y-axis and the second direction 24 parallel to the x-axis may be arranged orthogonal to each other. A separate quantum rod alignment layer (not shown) in contact with the patterned color quantum rod layer 50 may be deposited between a rear substrate and the quantum rod layer 50. The backlight 120 emits light of the first wavelength range, which may include UV wavelengths, that can optically stimulate the aligned quantum rod layers 50R, 50G, 50B.

In some embodiments, a separate LC alignment layer (not shown) may be deposited between the TFT electrode layer(s) 30 and the LC layer 40. A second separate LC alignment layer may be deposited between the non-TFT substrate 60 and the LC layer 40. The LC alignment layer may be deposited on the front substrate such that the LC alignment layer is in contact with the viewing side of the LC layer 40 and aligns the LC in a predetermined direction. The second LC alignment layer may be deposited on the rear substrate such that the second LC alignment layer is in contact with the non-viewing side of the LC layer 40 and aligns the LC in a predetermined direction. The predetermined LC alignment direction pertaining to the front substrate may be substantially parallel to (i.e., within ±15°) either the x-axis (planar alignment) or y-axis (planar alignment) or z-axis (vertical alignment).

In some embodiments, the patterned color quantum rod layer 50 may be used to align the LC layer on the rear substrate in a predetermined direction (e.g., the LC layer 40 is in direct contact with the patterned color quantum rod layer 50). When the LC alignment on the rear substrate is controlled by the patterned color quantum rod layer 50, then the patterned color quantum rod layer 50 can also be considered to be an LC alignment layer. An advantage of using the patterned color quantum rod layer 50 to align the LC layer 40 is to reduce manufacturing costs since a dedicated LC alignment layer is not required. The predetermined LC alignment direction pertaining to the rear substrate may be substantially parallel to (i.e., within ±15°) either the x-axis (planar alignment) or y-axis (planar alignment) or z-axis (vertical alignment). The predetermined LC alignment directions of the front and rear substrates may be substantially parallel (i.e., within ±15°) to the first direction 22 and/or the second direction 24.

In some embodiments, the predetermined LC alignment directions of the front and rear substrates may be suitable for an in-plane switching (IPS) LC mode, a fringe field switching (FFS) LC mode, a vertically aligned (VA) LC mode, a twisted nematic (TN) LC mode, or any other LC mode capable of modulating the transmission of light. Those skilled in the art of LCDs will appreciate that FFS, IPS, VA and TN LC modes may be configured to be switchable half-wave plates for the modulation of a light source.

Polarized light that traverses the LC layer 40 experiences retardation somewhere between 0λ retardation (no polarization change) to approximately λ/2 retardation (maximum polarization change). The amount of retardation experienced is a function of the voltage(s) applied across the LC layer 40 via a conventional arrangement of TFTs and electrodes.

In some embodiments, voltages may be applied via the TFT substrate 20 and related TFT electrode layer(s) 30 to switch LC molecules of the LC layer 40 in each sub-pixel. The voltages applied to the LC layer 40 can control the amount of light that exits each sub-pixel of the transflective display device 200 in the viewing direction 4. The spatial extent of each sub-pixel is substantially the same as the spatial extent of the aligned quantum rod layers 50R, 50G and 50B. For explanatory convenience, the aligned quantum rod layers 50R, 50G and 50B shall be used to represent the red, green and blue sub-pixels pertaining to the transflective display pixel 200.

The color sub-pixels formed by the aligned quantum rod layers 50R, 50G and 50B may comprise a white pixel. Switching the LC layer 40 may control the amount of light that propagates towards a viewer (i.e. propagates towards the viewing direction 4) from each of the aligned quantum rod layers 50R, 50G, 50B of the transflective display device 200. In particular, a voltage-controlled LC layer 40 can modulate the amount of light that exits the transflective display device 200 towards the viewing direction 4 (i.e., toward the viewer) from each of the aligned quantum rod layers 50R, 50G and 50B. In some embodiments, a 2-dimensional array of a plurality of transflective display pixels 200 can comprise the broader transflective display device. In some embodiments, the transflective display device can be configured to show high resolution images using a plurality of transflective display pixels 200.

FIG. 6 is a schematic drawing depicting another exemplary LCD optical stack arrangement of a transflective display device 201 in accordance with embodiments of the present invention. The optical stack may be part of a quantum rod transflective display device and comprises a transflective pixel 201. Like pixel 200, the transflective pixel 201 includes, from the viewing side 4, the front linear polarizer 10 with transmission axis arranged to transmit light with a first polarization in the first direction 22 (parallel to the y-axis), the TFT substrate 20, the one or more TFT electrode layers 30, the LC layer 40, the patterned color quantum rod layer 50, the non-TFT substrate 60, and the backlight 120. The transflective pixel 201 also includes an in-cell polarizer 70 with a transmission axis arranged to transmit light with a second polarization in the second direction 24 (parallel to the x-axis). The in-cell polarizer 70 may be a linear polarizer. The in-cell polarizer 70 may have a contrast ratio of >10:1. The in-cell polarizer 70 may have a dichroic ratio of >10:1. The in-cell polarizer 70 may have a transmission of >40% for unpolarised light. The in-cell polarizer 70 may be configured to reduce imperfect polarization of light emitted by the patterned color quantum rod layer 50. The in-cell polarizer 70 may be considered as a “clean-up” linear polarizer to improve the degree of polarization and/or reduce the ellipticity of the light emitted the patterned color quantum rod layer 50.

The in-cell polarizer 70 may be a liquid crystal polarizer. In FIG. 6, the TFT substrate 20 may be referred to as the “front substrate” or “viewing side substrate” while the non-TFT substrate 60 may be referred to as the “rear substrate” or “non-viewing side” substrate”. Many structural features of FIG. 6 have been previously described and so the ensuing discussion focuses on the additional feature of the in-cell polarizer 70 introduced in FIG. 6. In some embodiments, the in-cell polarizer 70 may be a liquid crystal polarizer (LC in-cell polarizer), a wire grid polarizer (wire grid in-cell polarizer), or have any other suitable configuration. Embodiments in which the in-cell polarizer 70 is a liquid crystal polarizer may include a separate LC alignment layer for the liquid crystal polarizer. The separate in-cell polarizer alignment layer (not shown) may be deposited between the rear substrate and the in-cell polarizer 70 and may be in direct contact with the in-cell polarizer 70.

In some embodiments, the aligned quantum rod layers 50R, 50G, 50B may be used to align the LC in-cell polarizer 70. For example, the LC in-cell polarizer 70 may be in direct contact with the aligned quantum rod layers 50R, 50G, 50B. When the alignment of the LC in-cell polarizer 70 on the rear substrate is controlled by the aligned quantum rod layers 50R, 50G, 50B then the aligned quantum rod layers 50R, 50G, 50B can also function as the alignment layer. Using the aligned quantum rod layers 50R, 50G, 50B to align the in-cell polarizer 70 may reduce manufacturing costs by removing the dedicated alignment layer for the in-cell polarizer 70 from the optical stack.

In some embodiments, the in-cell polarizer 70 may be a guest-host type LC polarizer such as a dye doped LC polarizer. The dye, or a mixture of dyes, and an LC material may be mixed and deposited on the separate LC in-cell polarizer alignment layer. The LC material of the LC polarizer may be, for example, a reactive mesogen (RM) material, a mixture of an LC material and polymer-precursors that can be subsequently polymerized to form a solid film, and the like. In some embodiments, the LC in-cell polarizer 70 may be a lyotropic LC dye, a mixture of lyotropic LC dyes, a mixture of lyotropic LC and a dye, a mixture of dyes, and the like. The lyotropic LC, the dye, or both may be polymerized to form a solid film. In the case of a lyotropic LC, the polymerization may occur before, during, or after evaporation of the lyotropic LC solvent. Alternatively, the in-cell LC polarizer 70 may be polymerized via a UV radiation exposure and/or a heating process. The in-cell LC polarizer 70 may improve the contrast ratio of the transflective display 201.

With reference to FIG. 6, a second separate LC alignment layer (not shown) in contact with the LC layer 40 may be deposited between the non-TFT substrate 60 and the LC layer 40. In some embodiments, the in-cell polarizer 70 may be used to align the LC layer 40 on the rear substrate in a predetermined direction. For example, the LC layer 40 may be in direct contact with the in-cell polarizer 70. Using the in-cell polarizer 70 to align the LC layer 40 may reduce manufacturing costs by removing the separate second alignment layer for the LC layer 40 from the optical stack. The predetermined alignment direction of the LC layer 40 pertaining to the rear substrate may be substantially parallel to (i.e. within ±15°) either the x-axis (planar alignment) or y-axis (planar alignment) or z-axis (vertical alignment).

FIG. 7 is a schematic drawing depicting another exemplary LCD optical stack arrangement of a transflective display device 202 in accordance with embodiments of the present invention. The optical stack may be part of a quantum rod transflective display device including a transflective pixel 202. Like pixels 200 and 201, the transflective pixel 202 includes, from the viewing side 4, the front linear polarizer 10 with a transmission axis arranged in the first direction 22 (parallel to the y-axis), the TFT substrate 20, the one or more TFT electrode layers 30, the LC layer 40, a patterned color quantum rod layer 50, the non-TFT substrate 60, and a backlight 120. The transflective pixel 202 also includes one or more non-TFT electrode layers 80. The TFT substrate 20 may be referred to as the “front substrate” or “viewing side substrate” while the non-TFT substrate 60 may be referred to as the “rear substrate” or “non-viewing side” substrate”.

In some embodiments, a voltage may be applied to the one or more non-TFT electrode layers 80 during the manufacturing process to align the patterned color quantum rod layer 50 in the second direction 24. The one or more non-TFT electrode layers 80 may be patterned. When the patterned color quantum rod layer 50 is aligned by the voltage applied by the one or more non-TFT electrode layers 80, the patterned color quantum rod layer 50 may be polymerized during application of the voltage to maintain alignment in the second direction 24 after the voltage has been removed.

In some embodiments, the patterned color quantum rod layer 50 may be polymerized after the alignment voltage has been removed. The quantum rods of the aligned quantum rod layers 50R, 50G and 50B may be directly polymerized. In some embodiments, the quantum rods may be embedded in a host matrix that may be polymerized. In conjunction with voltages that are applied via the TFT electrodes formed in the one or more TFT electrode layers 30, voltages may also be applied to the one or more non-TFT electrode layers 80 to switch the LC molecules of the LC layer 40 in each sub-pixel corresponding to the aligned quantum rod layers 50R, 50G and 50B in order to modulate the transmission of light. The modulations of the transmission of light may be used to form an image on the transflective display device 202.

FIG. 8 is a schematic drawing depicting another exemplary LCD optical stack arrangement of a transflective display device 203 in accordance with embodiments of the present invention. The optical stack may be part of a quantum rod transflective display device and may include a transflective pixel 203. The transflective pixel 203 includes, from the viewing side 4, a front linear polarizer 10 with transmission axis arranged in a first direction 22 (parallel to the y-axis), the TFT substrate 20, the one or more TFT electrode layers 30, the LC layer 40, the in-cell polarizer 70 with a transmission axis arranged in the second direction 24 (parallel to the x-axis), the patterned color quantum rod layer 50, the one or more non-TFT electrode layers 80, the non-TFT substrate 60, and the backlight 120. FIG. 8 combines the features of the in-cell polarizer 70 with the features of the one or more non-TFT Electrode layers 80 described herein. FIGS. 5-8 provide an enhanced optical stack with the TFT substrate 20 and the one or more TFT electrode layers on the viewing side of the LC layer 40 and the patterned color quantum rod layer 50.

Optical Stack with Non-TFT Substrate on Viewing Side

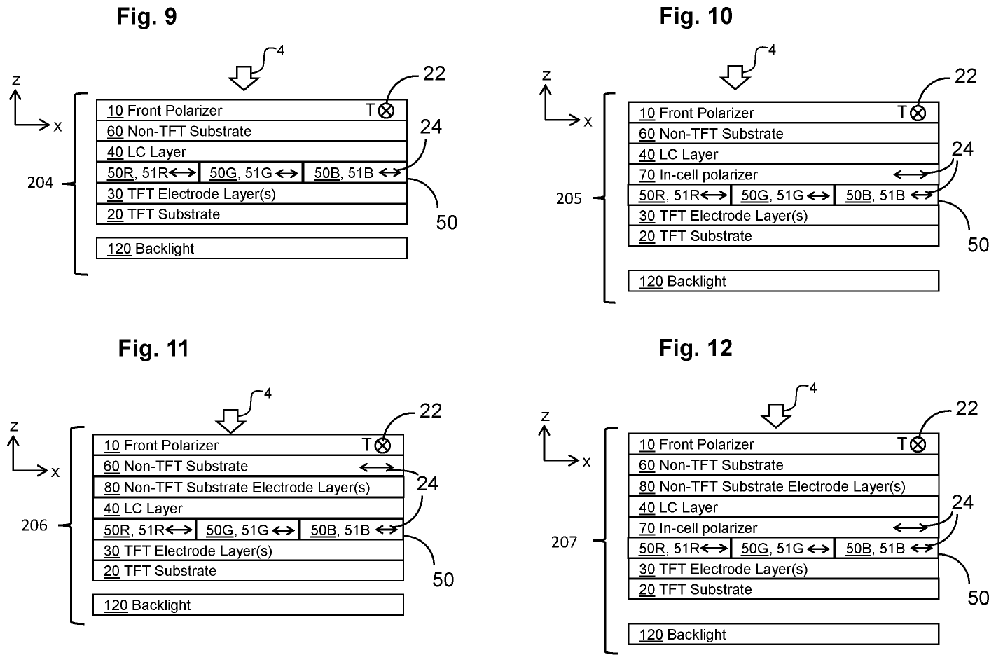

In the previous embodiments, the TFT substrate is on the viewing side relative to the non-TFT substrate. The positions of the two substrates may be reversed, with instead the non-TFT substrate being on the viewing side relative to the non-TFT substrate. The other optical components operate similarly. Accordingly, FIGS. 9-12 depict alternative embodiments in which the non-TFT substrate is on the viewing side.

Specifically, FIG. 9 is a schematic drawing depicting another exemplary LCD optical stack arrangement of a transflective display device 204 in accordance with embodiments of the present invention. A transflective pixel 204 of a quantum rod transflective display device includes, from the viewing side 4, the front linear polarizer 10 with a transmission axis arranged in the first direction 22 (parallel to the y-axis), the non-TFT substrate 60, the LC layer 40, the patterned color quantum rod layer 50, the one or more TFT electrode layers 30, the TFT substrate 20 and the backlight 120. In FIG. 9, the non-TFT substrate 60 may be referred to as the “front substrate” or “viewing side substrate” while the TFT substrate 20 may be referred to as the “rear substrate” or “non-viewing side” substrate”. The structural layer features of FIG. 9 previously described herein are identified using like reference numbers.

In some embodiments, a voltage may be applied to the one or more TFT electrode layers 30 during the manufacturing process to align the quantum rod layers 50R, 50G and 50B of the patterned color quantum rod layer 50 in the second direction 24. The one or more TFT electrode layers 30 may be patterned. The aligned quantum rod layers 50R, 50G and 50B may be polymerized during application of the voltage by the one or more TFT electrode layers 30, to maintain alignment in the second direction 24 after the voltage has been removed.

In some embodiments, the aligned quantum rod layers 50R, 50G and 50B may be polymerized after an alignment voltage has been removed. In some embodiments, the quantum rods of the aligned quantum rod layers 50R, 50G and 50B may be directly polymerized. In other embodiments, a host matrix in which the quantum rods are embedded may be polymerized to form the aligned quantum rod layers 50R, 50G and 50B.

FIG. 10 is a schematic drawing depicting another exemplary LCD optical stack arrangement of a transflective display device 205 in accordance with embodiments of the present invention. A transflective pixel 205 of a quantum rod transflective display device may include, from the viewing side 4, the front linear polarizer 10 with a transmission axis arranged in the first direction 22 (parallel to the y-axis), the non-TFT substrate 60, the LC layer 40, the patterned color quantum rod layer 50, the one or more TFT electrode layers 30, the TFT substrate 20, the backlight 120, and an in-cell polarizer 70. The in-cell polarizer 70 included in the transflective pixel 205 may be disposed between the LC layer 40 and the patterned color quantum rod layer 50.

FIG. 11 is a schematic drawing depicting another exemplary LCD optical stack arrangement of a transflective display device 206 in accordance with embodiments of the present invention. A transflective pixel 206 of a quantum rod transflective display device may include, from the viewing side 4, the front linear polarizer 10 with a transmission axis arranged in the first direction 22 (parallel to the y-axis), the non-TFT substrate 60, the LC layer 40, the patterned color quantum rod layer 50, the one or more TFT electrode layers 30, the TFT substrate 20, the backlight 120, and one or more non-TFT substrate electrode layers 80. The one or more non-TFT substrate electrode layers 80 may be disposed between the non-TFT substrate 60 and the LC layer 40.

FIG. 12 is a schematic drawing depicting another exemplary LCD optical stack arrangement of a transflective display device 207 in accordance with embodiments of the present invention. A transflective pixel 207 of a quantum rod transflective display device includes both the one or more non-TFT electrode layers 80 and the in-cell polarizer 70 described herein in the optical stack with the non-TFT substrate 60 as the “front substrate” and the TFT substrate 20 as the “rear substrate”. All the individual structural features are identified using like reference number and have been previously described herein.

### Generating and Transforming Quantum Rod Emitted Light

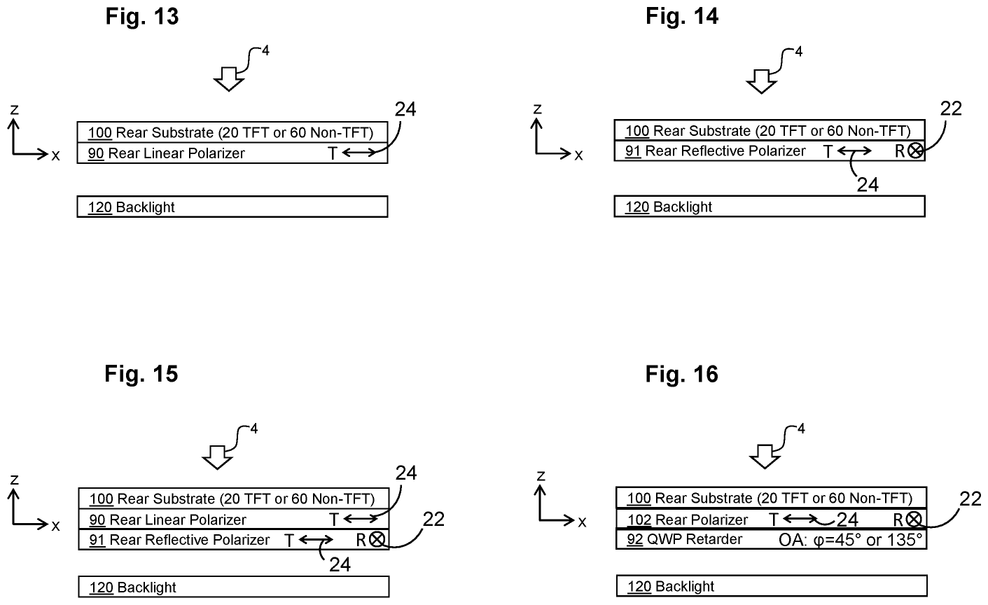

FIG. 13 is a schematic drawing depicting an arrangement of a rear polarizer suitable for a transflective display device in accordance with embodiments of the present invention. The rear polarizer arrangement may be used in combination with any of the transflective devices of the previous embodiments. Accordingly, a transflective display device may include a rear linear polarizer 90 to transform light emanating from the backlight 120 and used to excite the quantum rod layer to polarized light. The rear linear polarizer 90 may be used to increase the contrast ratio of the transflective display device. The rear linear polarizer 90 may be laminated to the rear substrate 100 of any other embodiment described herein. For example, in an optical stack with the non-TFT substrate 60 on the viewing side 4, the rear substrate 100 may be the TFT substrate 20 (as shown in FIGS. 9, 10, 11 and 12). In embodiments with the TFT substrate 20 on the viewing side 4, the rear substrate 100 may be the non-TFT substrate 60 (as shown in FIGS. 5, 6, 7 and 8). The transmission axis of the rear linear polarizer 90 is arranged in the second direction 24 (parallel to the x-axis). In some embodiments, the rear linear polarizer 90 may be added to the optical stack to improve the contrast ratio of quantum rod transflective display devices described herein.

FIG. 14 is a schematic drawing depicting an arrangement of another rear polarizer suitable for a transflective display device in accordance with embodiments of the present invention. The transflective display device may include a rear reflective polarizer 91 (such as a DBEF) to increase the brightness of the transflective display device by reflecting light towards the backlight 120 that is polarised parallel to the first direction (parallel to the y-axis) and has emanated from the backlight 120. The light reflected towards the backlight 120 in this manner by the rear reflective polariser 24 may be converted to the orthogonal linear polarisation (i.e. become polarized parallel to second direction, parallel to the x-axis) within the backlight and such light polarized parallel to second direction will be subsequently transmitted by the rear reflective polariser 24 upon exiting the backlight. The rear reflective polarizer 91 may be laminated to the rear substrate 100 of any other embodiment of transflective devices described herein. The transmission axis of the rear reflective polarizer 91 is arranged in the second direction 24 (parallel to the x-axis) and the reflection axis is arranged in the first direction 22 (parallel to the y-axis). In some embodiments, the rear reflective polarizer 91 may be added to the optical stack to improve the contrast ratio and/or brightness of quantum rod transflective display devices described herein.

FIG. 15 is a schematic drawing depicting an arrangement of another rear polarizer suitable for a transflective display device in accordance with embodiments of the present invention. The transflective display device may include a rear linear polarizer 90 and a rear reflective polarizer 91 laminated to the rear substrate 100 of any other embodiment of transflective devices described herein. The combination of the rear linear polarizer 90 and the rear reflective polarizer 91 may be implemented to increase the brightness and/or contrast ratio of the transflective display device. The transmission axes of the rear linear polarizer 90 and rear reflective polarizer 91 are arranged in the second direction 24 (parallel to the x-axis) and the reflection axis of the reflective polarizer 91 is arranged in the first direction 22 (parallel to the y-axis).

FIG. 16 is a schematic drawing depicting an arrangement of a rear polarizer and retarder combination suitable for a transflective display device in accordance with embodiments of the present invention. The transflective display device may include a rear polarizer 102 such as the rear linear polarizer 90, the rear reflective polarizer 91 and/or a combination thereof. In some embodiments, the rear polarizer 102 may be laminated to the rear substrate 100 and a quarter-wave plate retarder 92 may be laminated to the rear polarizer 102. The quarter-wave plate retarder 92 may increase the brightness of the transflective display device.

The quarter wave plate may be characterized by an optical axis defined by an in-plane angle φ. The optical axis of the quarter-wave plate retarder 92 may be arranged at substantially (i.e. within ±15°) φ=45° or φ=135° to the first direction 22 or second direction 24 respectively. The arrangement in FIG. 16 may be applied to any other embodiment of transflective devices described herein. In some embodiments, the rear substrate 100 may be comprised of one or more polarizers arranged to have transmission axes arranged in the second direction 24 (parallel to the x-axis) and one or more polarizers arranged to have reflection axes in the first direction 22 (parallel to the y-axis). The rear polarizer 102 may be added to the optical stack to improve the contrast ratio and/or brightness of quantum rod transflective display devices described herein. The quarter-wave plate retarder 92 may be added to the optical stack to improve the brightness of quantum rod transflective display devices described herein.

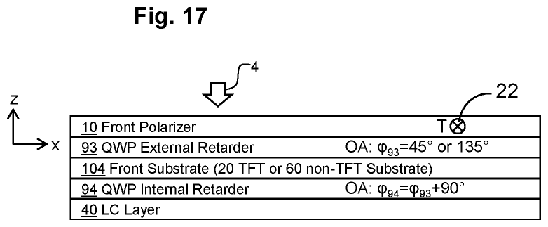

FIG. 17 is a schematic drawing depicting an arrangement of external and internal quarter wave plates on opposite sides of the front substrate of a transflective display device in accordance with embodiments of the present invention. The transflective display device may include an external quarter-wave plate retarder 93 disposed between the front polarizer 10 and a front substrate 104. An optical axis of the external quarter wave plate retarder 93 may be configured with an azimuthal angle, φ₉₃, relative to the transmission axis 22 of the front polarizer 10. In some embodiments, the azimuthal angle, φ₉₃ may be 45°±15° or 135°±15°. In some embodiments, the transflective display device may include an internal quarter wave plate retarder 94 disposed between the LC layer 40 and the front substrate 104. The azimuthal angle, φ₉₃, of the external quarter wave plate retarder 93 optical axis and the azimuthal angle, φ₉₄, of the internal quarter wave plate retarder 94 optical axis are arranged to cancel the optical functions of each other. If both the external quarter wave plate retarder 93 and the internal quarter wave plate retarder 94 are both positive uniaxial materials or both negative uniaxial materials, then the azimuthal angle, φ₉₄, of the internal quarter wave plate retarder 94 optical axis is arranged at substantially (i.e., within ±15°) 90° relative to the azimuthal angle, φ₉₃, of the external quarter wave plate retarder 93 optical axis (i.e. φ₉₄=φ₉₃+90°±15°). If the external quarter wave plate retarder 93 and the internal quarter wave plate retarder 94 are uniaxial materials of opposite polarity then the azimuthal angle, φ₉₄, of the internal quarter wave plate retarder 94 optical axis is arranged at substantially (i.e., within ±15°) 0° relative to the azimuthal angle, φ₉₃, of the external quarter wave plate retarder 93 optical axis (i.e. φ₉₄=φ₉₃+0°±15°).

The quarter wave plate retarders may be used to reduce unwanted ambient reflections from the transflective display device and therefore improve the contrast ratio of the quantum rod transflective display devices described herein. The arrangement of FIG. 17 may be employed on the viewing side of the quantum rod layer 50 of any of the previous embodiments.

### Operation of a Transflective Pixel

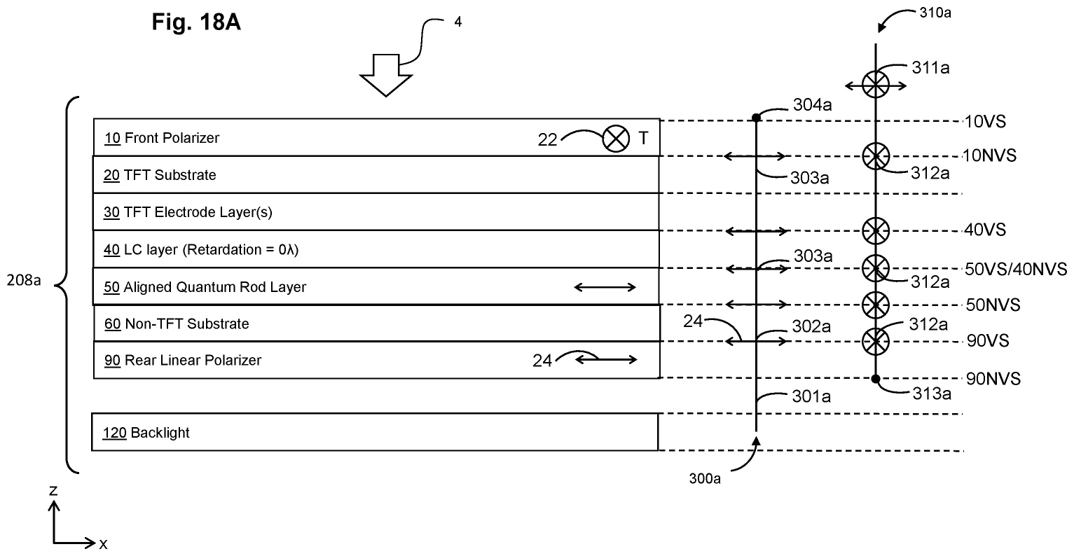

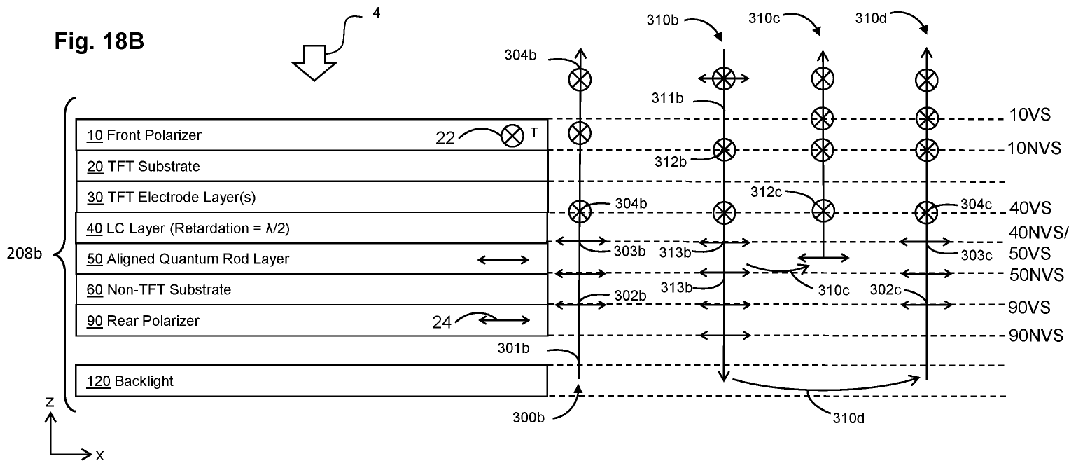

FIG. 18A is a schematic drawing depicting the operation of polarization optics in a transflective display device 208a in a black state in accordance with embodiments of the present invention. As an example, the transflective display device 208a combines the optical stack shown in FIG. 5 with the TFT substrate 20 on the viewing side 4 and the optical stack shown in FIG. 13 with the rear linear polarizer 90. In general, any of the FIGS. 5 to 12 may be combined with one or more of the FIGS. 13 through 17 and FIGS. 20 through 21 to enable a quantum rod transflective a display device. One of ordinary skill in the art would recognize many variations, modifications, and alternatives.

The backlight 120 may be configured to reflect (e.g., via a metallic surface or dielectric ESR film) incoming light 310a, and to emit light 300a, to the rear linear polarizer 90. In some embodiments, the LC layer 40, the front polarizer 10, the rear polarizer 90, and the one or more TFT electrode layers 30 may modulate the phase shift of light that traverses the LC layer 40 between 0λ (no polarization change, i.e., configuring the device to a black state) to λ/2 (maximum polarization change, i.e., configuring the device to a white state). It will be appreciated by those skilled in the art that the phase change experienced by light traversing the LC layer in the black state is ideally and exactly equal to 0λ, but that in reality, the phase change is substantially equal to 0λ owning to conventional manufacturing tolerances. It will be appreciated by those skilled in the art that the phase change experienced by light traversing the LC layer in the white state is ideally and exactly equal to λ/2 for each of the red, green and blue sub-pixels but that in reality the phase change is substantially equal to λ/2 owning to conventional manufacturing tolerances and/or dispersion of the LC material. The amount of phase shift may be a function of the voltage applied across the LC layer 40. The voltage across the LC layer 40 may be controlled by the one or more TFT electrode layers 30. In FIG. 18A the transflective pixel 208 is configured using a voltage (which may be zero) so that the LC layer 40 imparts 0λ phase shift to light that traverses the LC layer 40 thus placing the device in a black state. In other words, the LC layer 40 does not change the polarisation sate of light in order to create a black state for the device.

In some embodiments, an intermediate voltage between the minimum and maximum applied across the LC layer 40 will create an intermediate retardation between 0λ and λ/2. In this manner, the intermediate voltage may create a grey scale state that has a brightness between the black state and white state. Light traversing the LC layer 40 in FIG. 18A experiences 0λ retardation (i.e. minimum retardation). FIG. 18A shows emitted light 300a traversing the LC layer 40 that originated from the position of the backlight 120 (i.e., light emanating from the non-viewing side and travelling towards the viewing side 4). FIG. 18A also shows incoming light 310a traversing the LC layer 40 that originated from the ambient environment (i.e. light emanating from the viewing side 4 and travelling towards the non-viewing side).

The transflective pixel 208a can modulate both emitted light 300a and incoming light 310a. The emitted light 300a is emitted from the backlight 120 in an unpolarized state 301a. The emitted light 300a enters the rear linear polarizer 90 and is transformed to a linearly polarized state 302a in the second direction 24. The emitted light 300a in the linearly polarized state 302a excites the quantum rods in the aligned quantum rod layer 50 causing colored light 303a polarized in the second direction 24 to be emitted. The colored light 303a passes through the LC layer 40 and the one or more TFT electrode layers 30, and the TFT substrate 20. The front polarizer 10 has a transmission axis arranged in the first direction 22 and blocks, at 304a, the colored light 303a in the linearly polarized state 302a. Accordingly, for the black state, light emitted from the backlight is not emitted from the transflective display device.

Based on the above, emitted light 300a travelling from the backlight 120 exits the rear polarizer 90 on the viewing side (VS) position 90VS that is linearly polarized in the second direction 24 that is parallel to the x-axis. Emitted light 300a entering the non-viewing side (NVS) of the aligned quantum rod layer 50 at position 50NVS is linearly polarized in the second direction 24. The aligned quantum rod layer 50 absorbs light linearly polarized in the second direction 24 and emits light that is linearly polarized in the second direction 24 that subsequently traverses the LC layer 40. The light absorbed and emitted from the aligned quantum rod layer 50 may be of different wavelengths as described herein. The aligned quantum rod layer 50 may emit a portion of light that propagates back towards the backlight that is not shown in FIG. 18A. In the black state, the LC layer 40 is not configured to change the polarization state of the emitted light 300a (i.e. the light entering the LC layer 40 at position 40NVS has the same polarization state as light exiting the LC layer 40 at position 40VS). The light exiting the LC layer 40 is polarized in the second direction 24 and absorbed by the front polarizer 10 that has a transmission axis aligned in the first direction 22. Therefore, emitted light 300a is not observed by the display user. The termination (i.e. absorption) of the ray path 300a is shown by the solid circle at position 10VS.

Similarly, the transflective pixel 208a can be configured to absorb the incoming light 310a from the ambient environment when the pixel is in a black state. The incoming light 310a incident on the surface of the front polarizer 10 may be in an unpolarized state 311a. The incoming light 310a is transformed by the front polarizer 10 to a linearly polarized state 312a in the first direction 22 aligned with the transmission axis of the front polarizer 10. The incoming light 310a in the linearly polarized state 312a passes through the TFT substrate 20, the one or more TFT electrode layers 30, the LC layer 40 with zero phase shift, the aligned quantum rod layer 50, and the non-TFT substrate. Because the quantum rods of the quantum rod layer are aligned in the second direction 24, the incoming light 310a passes through the aligned quantum rod layer 50 without exciting the quantum rods. However, in reality, some degree of excitation of the quantum rod layer 50 may occur. Thus, according to FIG. 18A, no light is emitted from the aligned quantum rod layer 50 when the polarization state of light passing through is aligned in a direction opposite to the alignment of the long axis of the quantum rods. The rear linear polarizer 90 has a transmission axis arranged in the second direction 24 and blocks without reflection at 313a the incoming light 310a in the linearly polarized state 312a. The rear linear polarizer 90 thus prevents incoming light 310a from reflecting off the backlight 120 and being emitted from the transflective pixel 208, such that for the black state ambient incoming light is not ultimately emitted from the transflective display device.

Based on the above, when incoming light 310a exits the front polarizer 10 on the non-viewing side position 10NVS and travels towards the backlight 120, the light is polarized in the first direction 22 that is parallel to the y-direction (into the plane of the page). Light entering the LC layer 40 on the viewing side position 40VS is polarized in the first direction 22. The LC layer 40 does not change the polarization state of the incoming light 310a and therefore light exiting the LC layer 40 at the non-viewing side position 40NVS remains polarized in the first direction 22. A proportion of the incoming light 310a may be absorbed by the aligned quantum rod layer 50. The remaining incoming light 310a that exits the aligned quantum rod layer 50 and travels towards the backlight 120 is subsequently absorbed by the rear polarizer 90. Therefore, incoming light 310a is not observed by the display user. The termination by absorption of the incoming light 310a is shown by the solid circle 313a at position 90NVS.

FIG. 18B is a schematic drawing depicting the operation of polarization optics in a transflective display device having the same optical stack as in FIG. 18A but configured to be in a white state in accordance with embodiments of the present invention. The transflective pixel 208b may be in a white state or colored state, with light traversing the LC layer 40 experiencing a λ/2 phase shift (i.e., maximum retardation). The LC layer 40 may be configured by applying a voltage using the one or more TFT electrode layers 30. As above, comparable principles may be applied to the various other structural embodiments.

The transflective pixel can modulate emitted light 300b and incoming light 310b. The emitted light 300b is emitted from the backlight 120 in an unpolarized state 301b. The emitted light 300b enters the rear linear polarizer 90 and may be transformed to a linearly polarized state 302b in the second direction 24. The emitted light 300b in the linearly polarized state 302b optically excites the aligned quantum rod layer 50 and the aligned quantum rod layer emits linearly polarized colored light 303b in the second direction 24 into the LC layer 40. The LC layer 40 is configured to introduce a phase shift of λ/2 to rotate the linearly polarized colored light 303b to a second linearly polarized state 304b aligned with the first direction 22. The linearly polarized colored light 304b passes through the one or more TFT electrode layers 30, the TFT substrate 20 and the front polarizer 10 because the light 304b is aligned with the transmission axis in the first direction 22. Thus, for the color (or white) state light emitted from the backlight is ultimately emitted from the transflective display device to the viewer.

Based on the above, emitted light 300b exiting the rear polarizer 90 on the viewing side position 90VS is linearly polarized in the second direction 24 that is parallel to the x-axis. Emitted light 300b entering the aligned quantum rod layer 50 at position 50NVS is linearly polarized in the second direction. The aligned quantum rod layer 50 absorbs light linearly polarized in the second direction 24 and emits light that is linearly polarized in the second direction 24 that subsequently traverses the LC layer 40. The emitted light 300b absorbed and emitted from the quantum rod layer 50 may be of different wavelengths as described previously. The aligned quantum rod layer 50 may emit a portion of light (not shown) that propagates back towards the backlight. The LC layer 40 changes the polarization state of the emitted light 300b (i.e. the light entering the LC layer 40 at position 40NVS is linearly polarized in the second direction 24 and light exiting the LC layer 40 at position 40VS is linearly polarized in the first direction 22). The light exiting the LC layer 50 is polarized in the first direction 22 and is transmitted by the front polarizer 10 that has a transmission axis aligned in the first direction 22. Therefore, emitted light 300b is observed by the display user.

The transflective pixel 208b can be configured to reflect the incoming light 310b from the ambient environment when the pixel is in a white or color state. The incoming light 310b incident to the surface of the front polarizer may be in an unpolarized state 311b. The incoming light 310b may be transformed by the front polarizer 10 to a first linearly polarized state 312b in the first direction 22 aligned with the transmission axis of the transflective pixel 208. The incoming light 310b in the first linearly polarized state 312b passes through the TFT substrate 20 and the one or more TFT electrode layers 30 before passing through the LC layer 40 that is configured to shift the phase λ/2 wavelengths. The LC layer 40 transforms the incoming light 310b to a second linearly polarized state 313b aligned in the second direction 24. The incoming light 310b in the second linearly polarized state 313b may excite the aligned quantum rod layer 50 and cause emitted light 310c to propagate in the direction of the viewing side 4 at the second linearly polarized state 313b aligned with the second direction 24. The emitted light 310c is transformed by the LC layer 40 to the first linearly polarized state 312c aligned with the first direction 22 and passes through the one or more TFT electrode layers 30, the TFT substrate 20, and the front polarizer 10 and exits the viewing side 4 of the transflective pixel 208, such that for the color (white) state ambient incoming light is ultimately emitted from the transflective display device.

Furthermore, the incoming light 310b in the second linearly polarized state 313b may excite the aligned quantum rod layer 50, which further causes incoming light 310b in the second linearly polarized state 313b to propagate toward the backlight 120. The backlight 120 may reflect the incoming light 310b to further produce emitted light 310d for enhanced efficiency in the color (white) state. The emitted light 310d enters the rear linear polarizer 90 and may be transformed to a first linearly polarized state 302c in the second direction 24. The emitted light 310d in the linearly polarized state 302c may excite the aligned quantum rod layer 50 and the aligned quantum rod layer 50 may emit colored light 303c that is linearly polarized in the second direction 24 into the LC layer 40. The LC layer 40 is configured to introduce a phase shift of λ/2 to rotate the linearly polarized colored light 303c to a second linearly polarized state 304c aligned with the first direction 22. The linearly polarized colored light 304c passes through the one or more TFT electrode layers 30, the TFT substrate 20 and the front polarizer 10 because it is aligned with the transmission axis in the first direction 22.

Based on the above, when incoming light 310b exits the front polarizer 10 on the non-viewing side position 10NVS and travels towards the backlight 120, the light is polarized in the first direction 22 that is parallel to the y-direction (into the plane of the page). Light entering the LC layer 40 on the viewing side position 40VS is polarized in the first direction 22. The LC layer 40 changes the polarization state of the incoming light 310b (i.e. the light entering the LC layer 40 at position 40VS is linearly polarized in the first direction 22 and light exiting the LC layer 40 at position 40NVS is linearly polarized in the second direction 24). Light polarized in the second direction 24 enters the aligned quantum rod layer 50 and optically excites the aligned quantum rods. The aligned quantum rod layer 50 emits light 310c that is polarized in the second direction 24 back towards the viewing side 4. The LC layer 40 changes the polarization state of the emitted light 310c (i.e. the light entering the LC layer 40 at position 40NVS is linearly polarized in the second direction 24 and light exiting the LC layer 40 at position 40VS is linearly polarized in the first direction 22). The light exiting the LC layer 40 is polarized in the first direction 22 and is transmitted by the front polarizer 10 that has a transmission axis aligned in the first direction 22. Therefore, emitted light 310c may be observed by the display user.

The aligned quantum rod layer 50 also emits light 310b that is polarized in the second direction 24 that travels towards the backlight 120. Emitted light 310b may be reflected from the backlight 120 and becomes emitted light 310d. The description of polarization control by the rear polarizer 90, LC layer 40 and front polarizer 10 for light path 310d is identical to light path 300b. Therefore, light 310d is observed by the display user.

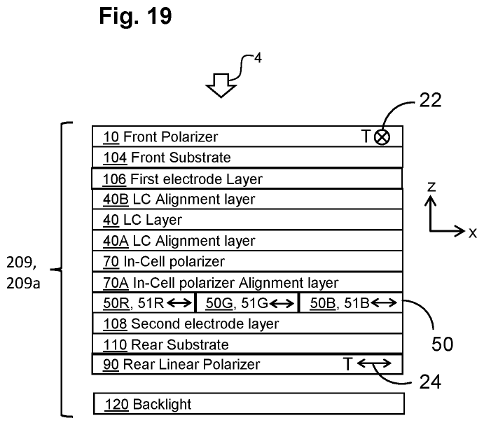

FIG. 19 is a schematic drawing depicting another exemplary LCD optical stack arrangement of a transflective display device in accordance with embodiments of the present invention. The LCD optical stack includes a transflective pixel 209a of a quantum rod transflective display device 209. The transflective pixel 209a may include, from the viewing side 4, a front linear polarizer 10 with transmission axis, T, arranged in a first direction 22 (parallel to the y-axis); a front substrate 104 such as a TFT substrate 20 or a non-TFT substrate 60; a first electrode layer such as TFT electrode layer 30 or non-TFT electrode layer 80 (dependent upon whether the front substrate is the TFT substrate 20 or the non-TFT substrate 60); a second LC alignment layer 40B arranged to induce LC alignment either parallel to the first direction 22 or perpendicular to the first direction 22; the LC layer 40, a first LC alignment layer 40A arranged to induce LC alignment either parallel to, or anti-parallel to, the alignment direction induced by the second LC alignment layer 40B; an in-cell polarizer 70 with transmission axis arranged in the second direction 24 (parallel to the x-axis), an in-cell polarizer alignment layer 70A arranged to induce alignment of the in-cell polarizer 70 transmission axis in the second direction 24 (parallel to the x-axis), a patterned color quantum rod layer 50, a second electrode layer 108 such as TFT electrode layer 30 or non-TFT electrode layer 80 (dependent upon whether the rear substrate is the TFT substrate 20 or non-TFT substrate 60), a rear substrate 110 such as a TFT substrate 20 or a non-TFT substrate 60 depending on the front substrate 104; a rear linear polarizer 90; and a backlight 120.

When the quantum rod transflective display device 209 has the TFT substrate 20 arranged as the front substrate 104, then the non-TFT substrate 60 is arranged as the rear substrate 110. Alternatively, if the quantum rod transflective display device 209 has the non-TFT substrate 60 arranged as the front substrate 104, then the non-TFT substrate 20 is arranged as the rear substrate 110. If the non-TFT substrate 60 is arranged as the front substrate 104, the front substrate 104 may or may not have the associated electrode layer 106. If the non-TFT substrate 60 is arranged as the rear substrate 110, the rear substrate 110 may or may not have the associated electrode layer 108.

Transflective Sub-Pixel with Selective Reflection Layers

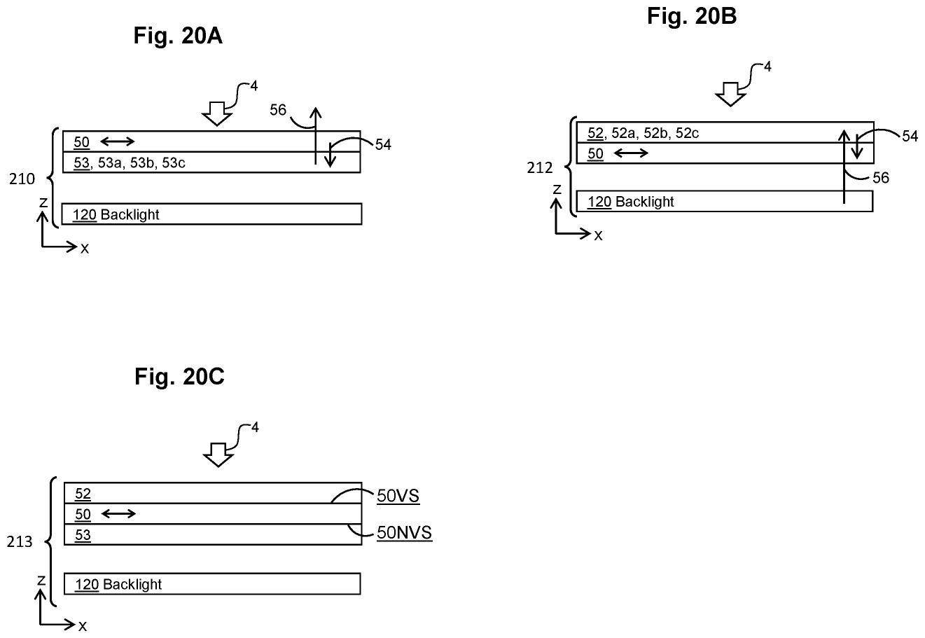

FIG. 20A is a schematic drawing of an exemplary arrangement of an aligned quantum rod layer and a selective reflection layer in accordance with embodiments of the present invention. The component stack 210 may be included in a transflective quantum rod display device described herein. The optical stack 210 may include a selective reflection layer 53 deposited between the backlight 120 and the aligned quantum rod layer 50. The selective reflection layer 53 may be designed such that it selectively transmits light of a first set of wavelengths which matches the wavelengths emitted by the backlight unit 120 while simultaneously reflecting light of a second set of wavelengths such as the wavelengths of light emitted by the aligned quantum rod layer 50. The selective reflection layer 53 may be configured to reflect light emitted by the aligned quantum rod layer 50 that is propagating towards the backlight 120 (i.e. propagating in the negative z direction 54) and re-directs this light towards the viewer (i.e. propagating in the positive z direction 56). Consequently, the selective reflection layer 53 may improve the brightness and efficiency of any transflective quantum rod display device described herein by effectively recycling light emitted by the aligned quantum rod layer 50.

The selective reflection layer 53 may be comprised of multiple layers for optimum reflection and transmission characteristics. The reflection layer 53 may be patterned in a similar manner to the one or more aligned quantum rod layers 50R, 50G and 50B such that a first selective reflection layer 53a is optimized to reflect light from the aligned quantum rod layer 50R, and/or a second selective reflection layer 53b is optimized to reflect light from the aligned quantum rod layer 50G, and/or a third selective reflection layer 53c is optimized to reflect light from the aligned quantum rod layer 50B. In some embodiments, the selective reflection layer 53 may be unpatterned and common to one or more of the aligned quantum rod layers 50R, 50G and 50B.

FIG. 20B is a further schematic drawing of an exemplary arrangement of an aligned quantum rod layer and a selective reflection layer in accordance with embodiments of the present invention. An LCD stack 212 may include a selective reflection layer 52. The selective reflection layer may be designed to selectively transmit light of a first set of wavelengths that at least includes wavelengths emitted by the aligned quantum rod layer 50 while simultaneously reflecting light of a second set of wavelengths such as the wavelengths of light emitted by the backlight 120. The selective reflection layer 52 reflects light emitted by the backlight 120 that is propagating towards the viewing side 4 (i.e. propagating in the positive z direction 56) and re-directs this light towards the Aligned Quantum Rod Layer 50 (i.e. propagating in the negative z direction 54). Consequently, the selective reflection layer 52 may improve the brightness and efficiency of any transflective quantum rod display device described herein by effectively recycling light emitted by the backlight unit 120.

The selective reflection layer 52 may be comprised of multiple layers for optimum reflection and transmission characteristics. The reflection layer 52 may be patterned in a similar manner to the aligned quantum rod layers 50R, 50G and 50B such that a first selective reflection layer 52a is optimized to transmit light from the aligned quantum rod layer 50R, and/or a second selective reflection layer 52b is optimized to transmit light from the aligned quantum rod Layer 50G, and/or a third selective reflection layer 52c is optimized to transmit light from the Aligned Quantum Rod Layer 50B. In some embodiments, the selective reflection layer 52 may be unpatterned and common to one or more of the aligned quantum rod layers 50R, 50G and 50B.

FIG. 20C is a further schematic drawing of an exemplary arrangement of an aligned quantum rod layer and a pair of selective reflection layers in accordance with embodiments of the present invention. An LCD stack 213 may include a first selective reflection layer 52 and a second selective reflection layer 53. The first selective reflection layer 52 may be coupled to the viewing side 50VS of the aligned quantum rod layer 50 and recycle light characterized by a wavelength associated with the backlight. The second selective reflection layer 53 may be coupled to the non-viewing side 50NVS of the aligned quantum rod layer 50 and recycle light characterized by a wavelength associated with the aligned quantum rod layer 50.

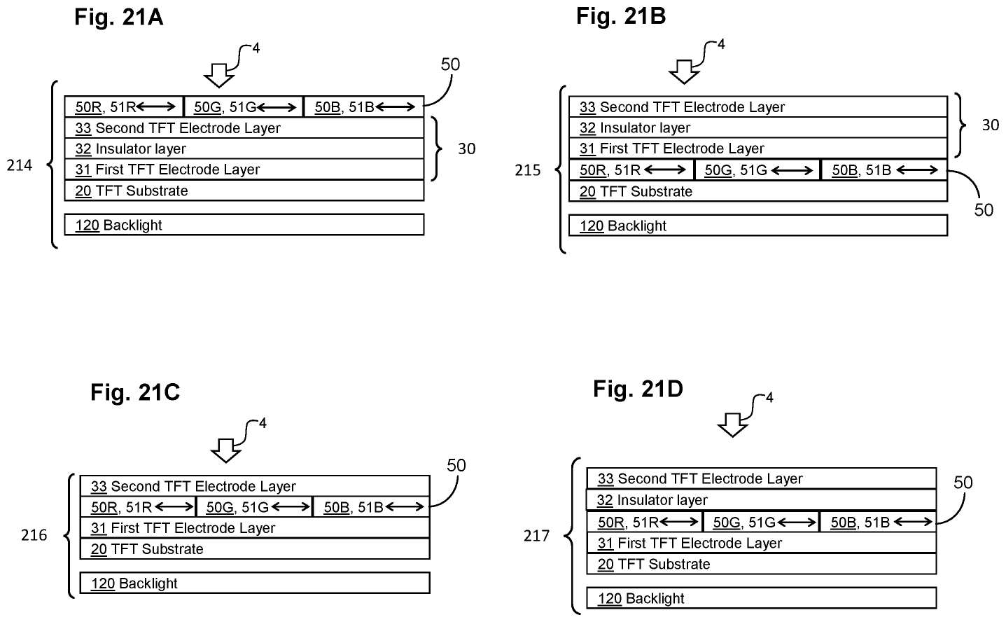

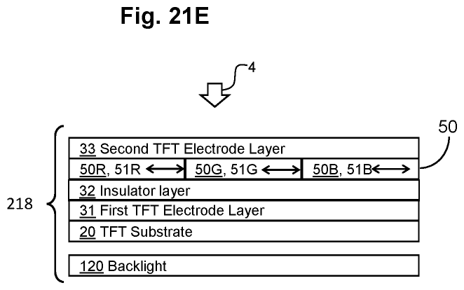

FIG. 21A, is a schematic drawing of an exemplary arrangement of the TFT substrate and one or more layers in accordance with embodiments of the present invention. The component stack 214 may be included in a transflective quantum rod display device described herein. An optical stack 214 may include from the viewing side 4 the aligned quantum rod layer 50; the one or more TFT electrode layers 30 comprising a second TFT electrode layer 33, an insulator layer 32, and a first TFT electrode layer 31; the TFT substrate 20; and the backlight 120. The insulator layer 32 may be an insulator layer configured to electrically separate the first electrode layer 31 and the second electrode layer 33 to prevent a short circuit. The first electrode layer 31 and/or the second electrode layer 33 may be a a patterned electrode layer or may be an unpatterned electrode layer. The first electrode layer 31, the second electrode layer 33, and the insulator layer 32 may be patterned according to a known design to enable an in-plane switching LC mode such as fringe field switching (FFS) LCD.

Any of the optical stacks 214-218 shown in FIGS. 21A-21E, may be used in combination with any quantum rod transflective display device described herein where the TFT substrate 20 is the rear substrate. For reasons of clarity, the other layers that comprise the quantum rod transflective display device have been omitted from FIGS. 21A-21E.

FIG. 21B is a further schematic drawing of an exemplary arrangement of the TFT substrate and associated layers in accordance with embodiments of the present invention. An optical stack 215 may include from the viewing side 4 the one or more TFT electrode layers comprising the second TFT electrode layer 33, the insulator layer 32, and the first TFT electrode layer 31; the aligned quantum rod layer 50; the TFT substrate 20; and the backlight 120.

FIG. 21C is a further schematic drawing of an exemplary arrangement of the TFT substrate and associated layers in accordance with embodiments of the present invention. An optical stack 216 may include from the viewing side 4 the second TFT electrode layer 33, the aligned quantum rod layer 50, the first TFT electrode layer 31, the TFT substrate 20, and the backlight 120. Here, the aligned quantum rod layer 50 is also an insulator layer that may be used to electrically separate the first electrode layer 31 and the second electrode layer 33 to prevent a short circuit.

FIG. 21D is a further schematic drawing of an exemplary arrangement of the TFT substrate and associated layers in accordance with embodiments of the present invention. An optical stack 217 may include from the viewing side 4 the second TFT electrode layer 33, the insulator layer 32, the aligned quantum rod layer 50, the first TFT electrode layer 31, and the TFT substrate 20.

FIG. 21E, is a further schematic drawing of an exemplary arrangement of the TFT substrate and associated layers in accordance with embodiments of the present invention. An LCD stack 218 may include from the viewing side 4 the second TFT electrode layer 33, the aligned quantum rod layer 50, the insulator layer 32, the first TFT electrode layer 31, and the TFT substrate 20.

An aspect of the invention is a transflective display that can form an image by both transmitting and reflecting light from the same sub-pixels. In exemplary embodiments, the transflective display has a viewing side and a non-viewing and includes a front polarizer with a transmission axis arranged in a first direction; a front substrate coupled to the non-viewing side of the front polarizer; a liquid crystal (LC) layer coupled to the non-viewing side of the front substrate; a quantum rod layer with one or more quantum rods aligned in a second direction, wherein the quantum rod layer is coupled to the non-viewing side of the LC layer; a rear substrate coupled to the non-viewing side of the quantum rod layer; and a backlight coupled to the non-viewing side of the quantum rod layer, wherein the quantum rod layer emits at least partially polarized light with a major axis substantially parallel (i.e. within ±15°) to the second direction. Each of the one or more quantum rods includes a long axis and a short axis, and the long axis is substantially parallel to the second direction. The transflective display may include one or more of the following features, either individually or in combination.

In an exemplary embodiment of the transflective display, the rear substrate is a non-thin film transistor (TFT) substrate and the front substrate is a TFT substrate.

In an exemplary embodiment of the transflective display, the rear substrate is a TFT substrate and the front substrate is a non-TFT substrate.

In an exemplary embodiment of the transflective display, an in-cell polarizer is disposed between the LC layer and the quantum rod layer.

In an exemplary embodiment of the transflective display, the non-TFT substrate has a first electrode layer.

In an exemplary embodiment of the transflective display, the non-TFT has a patterned electrode layer.

In an exemplary embodiment of the transflective display, the transflective display further includes a rear linear polarizer disposed between the backlight and the rear substrate, wherein the transmission axis of the rear linear polarizer is parallel to the second direction.

In an exemplary embodiment of the transflective display, the rear polarizer is a reflective polarizer.

In an exemplary embodiment of the transflective display, the transflective display further includes a rear polarizer arrangement disposed between the backlight and the rear substrate, wherein the rear polarizer arrangement includes a rear linear polarizer having a transmission axis that is parallel to the second direction and a reflective polarizer having a reflective axis that is parallel to the first direction.

In an exemplary embodiment of the transflective display, the transflective display further includes a quarter wave plate retarder disposed between the rear polarizer and the backlight, wherein the quarter wave plate retarder has an in-plane angle of φ=45° or φ=135° relative to the first direction or second direction respectively.

In an exemplary embodiment of the transflective display, the transflective display further includes a selective reflection layer disposed between the backlight and the quantum rod layer.

In an exemplary embodiment of the transflective display, the transflective display further includes a second selective reflection layer disposed between the viewing side and the quantum rod layer.

In an exemplary embodiment of the transflective display, the rear substrate further comprises, from the non-viewing side: a TFT substrate; a first TFT electrode layer; an insulator layer; and a second TFT electrode layer.

In an exemplary embodiment of the transflective display, the quantum rod layer is either disposed between the TFT substrate and the second electrode layer or is disposed on the viewing side of the second electrode layer.

In an exemplary embodiment of the transflective display, the quantum rod layer is the insulator layer.

In an exemplary embodiment of the transflective display, the transflective display further includes a quarter wave plate external retarder disposed on the viewing side of the front substrate; and a quarter wave plate internal retarder disposed between the front substrate and the LC layer.

In an exemplary embodiment of the transflective display, the LC layer can be configured in a first state associated with no polarization change, 0λ, and a second state associated with maximum polarization change λ/2.

In an exemplary embodiment of the transflective display, the LC layer is configured to rotate the major axis of the partially polarized light to the first direction parallel to the transmission axis of the front polarizer.

In an exemplary embodiment of the transflective display, a portion of the partially polarized light is emitted toward the backlight.

In an exemplary embodiment of the transflective display, the backlight has a reflective surface configured to reflect light toward the front polarizer.

Another aspect of the invention is a method of operating the enhanced transflective display. In exemplary embodiments, the method includes the steps of: transmitting, by a front linear polarizer with a first transmission axis, incoming light with a polarization in a first direction parallel to the first transmission axis; configuring a liquid crystal (LC) layer to introduce zero phase shift to the polarization of the incoming light; passing, by a quantum rod layer, the incoming light, wherein the quantum rod layer has a plurality of quantum rods aligned in a second direction perpendicular to the first transmission axis; absorbing, by a rear linear polarizer with a second transmission axis in the second direction perpendicular to the first transmission axis, the incoming light; generating, by a backlight, emitted light with a random polarization; absorbing, by the rear linear polarizer, emitted light with a polarization not parallel to the second transmission axis; transmitting, by the rear linear polarizer, emitted light with a polarization parallel to the second transmission axis; exciting, by the emitted light with the polarization parallel to the second transmission axis, quantum rods aligned in the second direction; emitting, by the excited quantum rods, colored light polarized in the second direction; and absorbing, by the front linear polarizer with the first transmission axis, the colored light polarized in the second direction. The method of operating may include one or more of the following features, either individually or in combination.

In an exemplary embodiment of the method of operating, the method further includes applying a voltage to the LC layer to configure the LC layer to introduce a phase shift of substantially λ/2 to light incident on the LC layer; rotating, by the LC layer, the polarization of the incoming light to the second direction; exciting, by the incoming light with the polarization in the second direction, quantum rods aligned in the second direction; emitting, by the excited quantum rods, colored light polarized in the second direction; rotating, by the LC layer, the polarization of the colored light to the first direction; and transmitting, by the front polarizer with the first transmission axis, the colored light polarized in the first direction.

In an exemplary embodiment of the method of operating, the method further includes applying a voltage to the LC layer to configure the LC layer to introduce a phase shift of substantially λ/2 to light incident on the LC layer; rotating, by the LC layer, the polarization of the colored light to the first direction; and transmitting, by the front polarizer with the first transmission axis, the colored light polarized in the first direction.

In an exemplary embodiment of the method of operating, the method further includes reflecting, by the backlight, a portion of the colored light emitted by the quantum rods toward the rear linear polarizer; transmitting, by the rear linear polarizer, colored light polarized in the second direction; applying a voltage to the LC layer to configure the LC layer to introduce a phase shift of substantially λ/2 to light incident on the LC layer; rotating, by the LC layer, the polarization of the colored light to the first direction; and transmitting, by the front polarizer with the first transmission axis, the colored light polarized in the first direction.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

Embodiments of the present invention relate to configurations and operation of many LCD devices in which high image quality is required for all ambient lighting conditions. Examples of such devices include mobile phones including smartphones, personal digital assistants (PDAs), tablets, laptop computers, televisions, public information displays, and the like.

### REFERENCE SIGNS LIST

2—illustrative LC molecule
3—long axis of LC molecule
4—viewing direction
5—short axis of LC molecule
6—generalized LCD device
8—sub-pixel
10—front linear polarizer
11—transmissive area
12—reflective area
14—black mask area
16—sub-pixel
18—transflective area
19—black mask area
20—thin-film transistor (TFT) substrate
22—first direction
24—second direction
30—TFT electrode layers
31—first TFT electrode layer
32—insulator layer
33—second TFT electrode layer
40—liquid crystal (LC) layer
40A—first LC alignment layer
40B—second LC alignment layer
50—quantum rod layer
50B—aligned quantum rod layer for blue light
51B—blue light
50G—aligned quantum rod layer for green light
51G—green light
50R—aligned quantum rod layer for red light
51R—red light
52—selective reflection layer
52a—first selective reflection layer
52b—second selective reflection layer
52c—third selective reflection layer
53—selective reflection layer
53a—first selective reflection layer
53b—second selective reflection layer
53c—third selective reflection layer
54—negative z direction
56—positive z direction
60—non-TFT substrate
70—in-cell polarizer
70A—in-cell polarizer alignment layer
80—non-TFT electrode layers
90—rear linear polarizer
91—rear reflective polarizer
92—quarter-wave plate retarder
93—external quarter-wave plate retarder
94—internal quarter wave plate retarder
100—rear substrate
102—rear polarizer
104—front substrate
106—first electrode layer
108—second electrode layer
110—rear substrate
120—backlight
200—transflective pixel
201—transflective display device
202—transflective display device
203—transflective display device
204—transflective display device
205—transflective display device
206—transflective display device
207—transflective display device
208—transflective pixel
208a—transflective display device
208b—transflective pixel
209—transflective display device
209a—transflective pixel
210—optical stack
212—LCD stack
213—LCD stack
214—optical stack
215—optical stack
216—optical stack
217—optical stack
218—optical stack
300a—emitted light
300b—emitted light
301a—unpolarized light
301b—unpolarized light
302a—linearly polarized light in second direction
302b—linearly polarized light in second direction
302c—linearly polarized light in second direction
303a—colored light
303b—colored light
303c—colored light
304a—blocking of polarized light of second direction
304b—linearly polarized colored light in first direction
304c—linearly polarized colored light in first direction
310a-d—various light directions
311a—unpolarized light
311b—unpolarized light
312a—linearly polarized light in first direction
312b—linearly polarized light in first direction
312c—linearly polarized light in first direction
313a—blocking of polarized light of first direction
313b—linearly polarized light in second direction

1. A transflective display having a viewing side and a non-viewing side comprising:
a front polarizer with a transmission axis arranged in a first direction;
a front substrate coupled to the non-viewing side of the front polarizer;
a liquid crystal (LC) layer coupled to the non-viewing side of the front substrate;
a quantum rod layer with one or more quantum rods aligned in a second direction, wherein the quantum rod layer is coupled to the non-viewing side of the LC layer;
a rear substrate coupled to the non-viewing side of the quantum rod layer; and
a backlight coupled to the non-viewing side of the quantum rod layer;
wherein the quantum rod layer emits at least partially polarized light that is substantially linearly polarized with a major axis substantially parallel to the second direction; and
wherein each of the one or more quantum rods includes a long axis and a short axis, and the long axis is substantially parallel to the second direction.

2. The transflective display of claim 1 wherein the rear substrate is a non-thin film transistor (TFT) substrate and the front substrate is a TFT substrate.

3. The transflective display of claim 1 wherein the rear substrate is a TFT substrate and the front substrate is a non-TFT substrate.

4. The transflective display of claim 1 wherein an in-cell polarizer is disposed between the front substrate and the rear substrate and between the LC layer and the quantum rod layer, and the in-cell polarizer has a transmission axis in the second direction.

5. The transflective display of claim 1 wherein the non-TFT substrate has a first electrode layer.

6. The transflective display of claim 5, wherein the non-TFT substrate has a patterned electrode layer.

7. The transflective display of claim 1 further comprising a rear linear polarizer disposed between the backlight and the rear substrate, wherein the transmission axis of the rear linear polarizer is parallel to the second direction.

8. The transflective display of claim 7, wherein the rear polarizer is a reflective polarizer.

9. The transflective display of claim 1, further comprising a rear polarizer arrangement disposed between the backlight and the rear substrate, wherein the rear polarizer arrangement includes a rear linear polarizer having a transmission axis that is parallel to the second direction and a reflective polarizer having a reflective axis that is parallel to the first direction.

10. The transflective display of claim 7, further comprising a quarter wave plate retarder disposed between the rear polarizer and the backlight, wherein the quarter wave plate retarder has an in-plane angle of φ=45° or φ=135° relative to the first direction or second direction respectively.

11. The transflective display of claim 1 further comprising a selective reflection layer disposed between the backlight and the quantum rod layer.

12. The transflective display of claim 1 further comprising a second selective reflection layer disposed between the viewing side and the quantum rod layer.

13. The transflective display of claim 1 wherein the rear substrate further comprises, from the non-viewing side:
a TFT substrate;
a first TFT electrode layer;
an insulator layer; and
a second TFT electrode layer.

14. The transflective display of claim 13 wherein the quantum rod layer is either disposed between the TFT substrate and the second electrode layer or is disposed on the viewing side of the second electrode layer.

15. The transflective display of claim 13 wherein the quantum rod layer is the insulator layer.

16. The transflective display of claim 1 further comprising:
a quarter wave plate external retarder disposed on the viewing side of the front substrate; and
a quarter wave plate internal retarder disposed between the front substrate and the LC layer.

17. A method of operating a transflective display device comprising the steps of:
transmitting, by a front linear polarizer with a first transmission axis, incoming light with a polarization in a first direction parallel to the first transmission axis;
configuring a liquid crystal (LC) layer to introduce zero phase shift to the polarization of the incoming light;
passing, by a quantum rod layer, the incoming light, wherein the quantum rod layer has a plurality of quantum rods aligned in a second direction perpendicular to the first transmission axis;
absorbing, by a rear linear polarizer with a second transmission axis in the second direction perpendicular to the first transmission axis, the incoming light;
generating, by a backlight, emitted light with a random polarization;
absorbing, by the rear linear polarizer, emitted light with a polarization not parallel to the second transmission axis;
transmitting, by the rear linear polarizer, emitted light with a polarization parallel to the second transmission axis;
exciting, by the emitted light with the polarization parallel to the second transmission axis, quantum rods aligned in the second direction;
emitting, by the excited quantum rods, colored light polarized in the second direction; and
absorbing, by the front linear polarizer with the first transmission axis, the colored light polarized in the second direction.

18. The method of operating of claim 17, further comprising:
configuring the liquid crystal (LC) layer by applying a voltage to the LC layer to configure the LC layer to introduce a phase shift of substantially λ/2 to light incident on the LC layer;
rotating, by the LC layer, the polarization of the incoming light to the second direction;
exciting, by the incoming light with the polarization in the second direction, quantum rods aligned in the second direction;
emitting, by the excited quantum rods, colored light polarized in the second direction;
rotating, by the LC layer, the polarization of the colored light to the first direction; and
transmitting, by the front polarizer with the first transmission axis, the colored light polarized in the first direction.

19. The method of operating of claim 17, further comprising:
configuring the liquid crystal (LC) layer by applying a voltage to the LC layer to configure the LC layer to introduce a phase shift of substantially λ/2 to light incident on the LC layer;
rotating, by the LC layer, the polarization of the colored light to the first direction; and
transmitting, by the front polarizer with the first transmission axis, the colored light polarized in the first direction.

20. The method of operating of claim 17, further comprising:
reflecting, by the backlight, a portion of the colored light emitted by the quantum rods toward the rear linear polarizer;
transmitting, by the rear linear polarizer, colored light polarized in the second direction;
applying a voltage to the LC layer to configure the LC layer to introduce a phase shift of substantially λ/2 to light incident on the LC layer;
rotating, by the LC layer, the polarization of the colored light to the first direction; and
transmitting, by the front polarizer with the first transmission axis, the colored light polarized in the first direction.
